(19) United States
(12) Patent Application Publication
(10) Pub. No.: US 2026/0121760 A1
(43) Pub. Date: Apr. 30, 2026

(54) Transmitter, receiver, and associated transmission chain and information transmission method

(71) Applicant: THALES, Meudon (FR)

(72) Inventors: Tarik BENADDI, TOULOUSE (FR); Philippe Louis François POTIER, TOULOUSE (FR); Aubin Michel LECOINTRE, TOULOUSE (FR)

(21) Appl. No.: 19/365,255

(22) Filed: Oct. 22, 2025

(30) Foreign Application Priority Data
Oct. 25, 2024 (FR) FR2411697

(51) Int. Cl. H04B 10/532

(52) U.S. Cl. CPC H04B 10/532

(57) ABSTRACT

The present disclosure relates to a transmitter, including: an optical modulator, configured to modulate an electrical signal into an optical signal including a first polarization along a first polarization axis and a second polarization along a second polarization axis; an optical rotation module, configured to generate a rotated optical signal by performing a rotation of the first and second polarizations; an amplifier module, including: a polarization beam splitter, configured to separate the rotated optical signal into a first optical component along the first polarization axis and a second optical component along the second polarization axis; a first optical amplifier, configured to amplify the first optical component; a second optical amplifier, configured to amplify the second optical component; and a polarization beam combiner.

### CROSS-REFERENCE TO RELATED APPLICATIONS

This application claims benefit of French Application No. FR 24 11697, filed Oct. 25, 2024, which is incorporated herein by reference in its entirety.

### FIELD

The present invention relates to a transmitter, a receiver, a transmission chain, and an associated information transmission method.

### BACKGROUND

The development of new telecommunication services requiring high data rates, the competition from terrestrial networks with the deployment of 400 Gbit/s technology and beyond, as well as the desire to reduce the digital divide by allowing every citizen to benefit from the same quality of service, wherever they are, have caused a considerable increase in the transmission capacity needs of satellite operators, necessitating the deployment of additional systems.

Faced with such a capacity demand, traditional radio frequency technologies are reaching their limits. In this context, optical technologies, capitalizing on the developments of terrestrial telecommunications through very high-speed fiber optics, constitute an alternative for very high-speed data transmission. In particular, free-space optical communications are a promising solution for the next generation of very high-speed satellites.

However, the satellite optical channel presents several drawbacks. In particular, there is a strong signal degradation due to the composition of the atmospheric layers and turbulence. These phenomena cause deep fades, interrupting transmission between a transmitter and a receiver for several milliseconds.

To compensate for this problem, very high-power optical amplifiers are used at the transmitter to amplify the optical signal before free-space transmission. Furthermore, the optical signal is transmitted on two polarizations per wavelength to increase spectral efficiency. In this case, the use of one optical amplifier per polarization is common. However, unequal amplification between the two amplifiers leads to a disparity in the amplification of the two polarizations, compromising the quality of the optical signal and, as a result, the quality of the transmission.

More generally, optical fibers, polarization beam splitters, or PBS, and polarization beam combiners or PBC used in fiber optic telecommunication systems can also cause disparities in the amplitude of the two polarizations of the signal, and decrease the quality of the transmission.

To correct the unequal amplification of polarizations, different approaches have been explored, such as the use of signal processing algorithms, digital pre-coding at the transmitter level, and decoding at the receiver level, for example, via a polarization time code, or PTC, interleaving on the two polarizations, or analog gain control of the amplifiers. However, these solutions tend to increase the complexity of the algorithms needed for optical signal processing on both the transmitter and receiver sides or increase the complexity of an optical front end, also known as an air interface module, present in the transmitter to emit the optical signal to the receiver and in the receiver to receive the optical signal emitted by the transmitter.

Other solutions, like polarization mixing using a polarization mixer, are known, but require active control that increases the electrical power consumed by the transmitter.

### SUMMARY

The aim of the invention is to improve the transmission of an optical signal, in a simple manner and by limiting the electrical power consumed.

By means of the invention, the object is a transmitter, configured to convert input digital data into an amplified optical signal and to emit the amplified optical signal, the transmitter comprising:
an optical modulator, configured to modulate an electrical signal representing the input digital data into an optical signal comprising a first polarization along a first polarization axis and a second polarization along a second polarization axis, the optical signal representing the input digital data;
an optical rotation module, configured to generate a rotated optical signal by performing a rotation of the first and second polarizations of the optical signal according to a predefined rotation angle, strictly between 0+kπ/2 and π/2+kπ/2, with k an integer; and
an amplifier module, comprising:
   a polarization beam splitter, configured to separate the rotated optical signal into a first optical component along the first polarization axis and a second optical component along the second polarization axis;
   a first optical amplifier, configured to amplify the first optical component according to a predefined first gain;
   a second optical amplifier, configured to amplify the second optical component according to a predefined second gain; and
      a polarization beam combiner, configured to receive the first and second optical components, amplified by the respective first and second optical amplifiers, and to combine them into an amplified optical signal.

By means of this invention, when the polarization splitter separates the rotated optical signal, it divides the signal into two optical components, thanks to the prior insertion of the rotation according to an angle strictly between 0+kπ/2 and π/2+kπ/2 with k an integer. Each of these components comprises both polarizations of the optical signal. Thus, the amplification differences caused by disparities between the first and second optical amplifiers are applied to the two optical components in an equivalent manner. This limits the amplification variations between the two polarizations of the optical signal. In summary, this invention allows for balanced amplification of the two polarizations of the optical signal.

It is not necessary to apply complex algorithmic or numerical treatments to compensate for an amplification difference between the optical amplifiers. Thus, the transmitter allows the emission of the amplified optical signal in a simple manner. Moreover, the rotation module is a passive element, which does not consume electricity. The electrical power consumed by the transmitter is therefore limited.

According to other advantageous aspects of the invention, the transmitter comprises one or more of the following features, taken individually or in any technically possible combination:
A digital processing module, configured to convert the input digital data into the electrical signal, representing the input digital data.
An optical front end comprising at least one of the following devices: a collimation device, a pointing device, and a turbulence compensation device.
The optical modulator is configured to transmit the optical signal to the rotation module, and the rotation module is configured to transmit the rotated optical signal to the amplifier module via a polarization-maintaining fiber.
The optical rotation module comprises a birefringent crystal.
The rotation angle is between π/6+kπ/2 and π/3+kπ/2, preferably approximately equal to π/4+kπ/2, with k an integer.

The invention also comprises a receiver, adapted to receive the amplified optical signal emitted by the transmitter and to convert it into output digital data.

The reception and conversion of the amplified optical signal do not require complex numerical or algorithmic treatments.

According to other advantageous aspects of the invention, the receiver comprises the following feature:
an optical front end, configured to receive the amplified optical signal, the received amplified optical signal being called the received optical signal;
an amplifier module, configured to amplify the received signal into an amplified received optical signal;
an optical demodulator, configured to convert the amplified received optical signal into a received electrical signal; and
a digital processing module, configured to implement an adaptive equalization algorithm and convert the received electrical signal into the output digital data.

The invention also comprises a transmission chain comprising the transmitter and the receiver.

The invention also comprises an information transmission method, implemented by a transmission chain described previously, the method comprising at least the following steps:
modulation of the electrical signal representing the input digital data into the optical signal, by the optical modulator;
rotation of the first and second polarizations of the optical signal by the optical rotation module to generate the rotated optical signal;
amplification of the rotated optical signal by the amplifier module to generate the amplified optical signal;
emission of the amplified optical signal by the transmitter;
reception of the amplified optical signal by the receiver, the amplified optical signal received by the receiver being called the received optical signal; and
conversion of the received optical signal into output digital data by the receiver.

### BRIEF DESCRIPTION OF THE DRAWINGS

The invention will become clearer upon reading the following description, given solely by way of non-limiting example, and made with reference to the drawings wherein:

FIG. 1 is a representation of a transmission chain according to the invention,

FIG. 2 is a block diagram of the transmission chain of FIG. 1,

FIG. 3 is a diagram of a part of the transmission chain of FIG. 2,

FIG. 4 is a flowchart of an information transmission method according to the invention, with the method being implemented by the transmission chain of FIG. 1.

### DETAILED DESCRIPTION

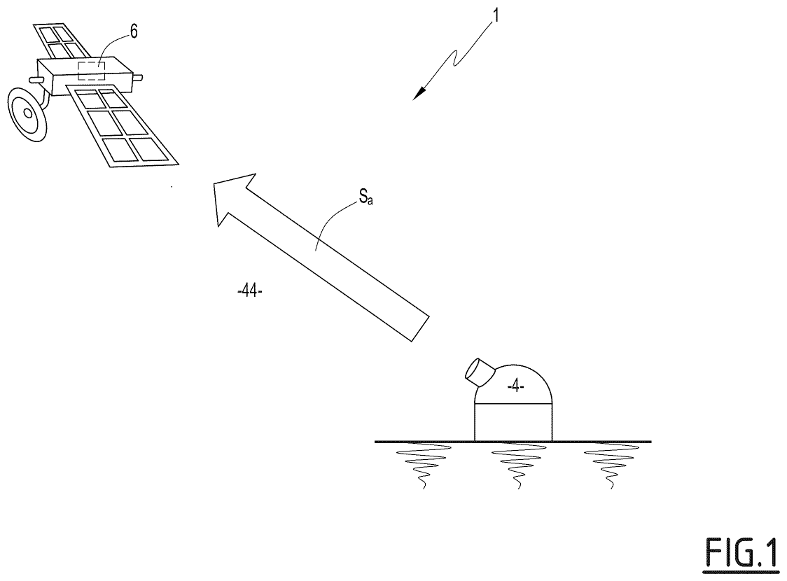

FIG. 1 represents a transmission chain 1 according to the invention.

The transmission chain 1 comprises a transmitter 4 and a receiver 6.

The transmitter 4 is advantageously located on the ground, in a telecommunications station, for example.

The receiver 6 is advantageously onboard an aircraft or satellite.

In a variant, the transmitter 4 is onboard an aircraft or satellite and the receiver 6 is on the ground, in a telecommunications station, for example. In another variant, both the transmitter 4 and the receiver 6 are on the ground.

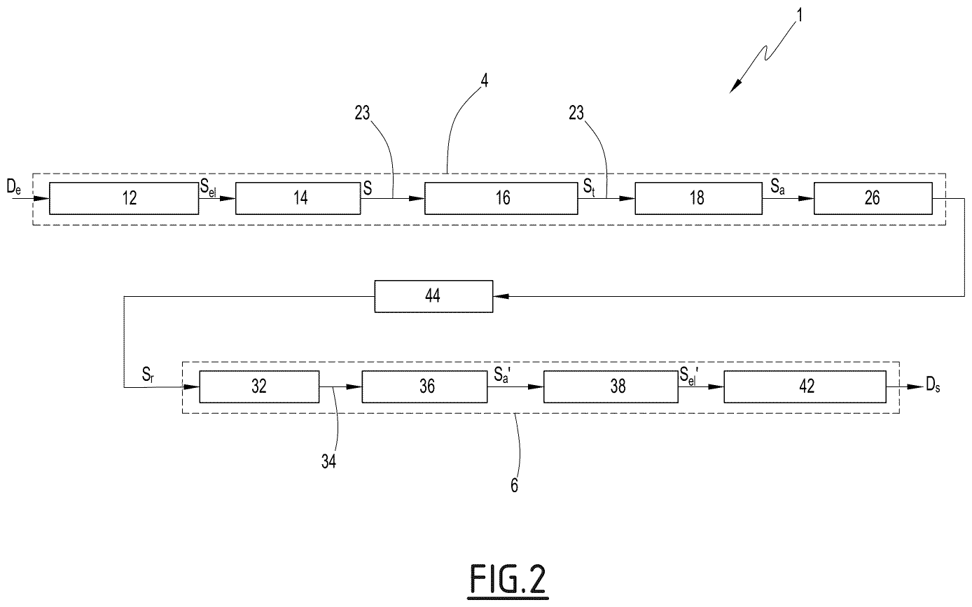

As shown in FIG. 2, the transmitter 4 advantageously comprises a digital processing module 12. The digital processing module 12 is implemented as a programmable logic component such as an FPGA (Field Programmable Gate Array), for example, or an integrated circuit such as an ASIC (Application Specific Integrated Circuit). In a variant, not shown, the digital processing module 12 is implemented as software, stored in the memory and executable by a processor associated with the memory. Likewise, in a variant, not shown, the digital processing module 12 is implemented by optical analog components.

The transmitter 4 also comprises an optical modulator 14, advantageously connected to the digital processing module 12. The optical modulator 14 is advantageously a dual-polarization Mach-Zehnder interferometer, comprising a laser source.

The transmitter 4 also comprises an optical rotation module 16, connected to the optical modulator 14. The optical rotation module 16 is passive and comprises a birefringent crystal, one or more quarter-wave plates or even one or more Faraday rotators, for example. “Passive” here means that it does not require power from an electrical source to operate, unlike an active device or module, which needs to be powered by an electrical source to function.

The transmitter 4 also comprises an amplifier module 18, connected to the optical rotation module 16.

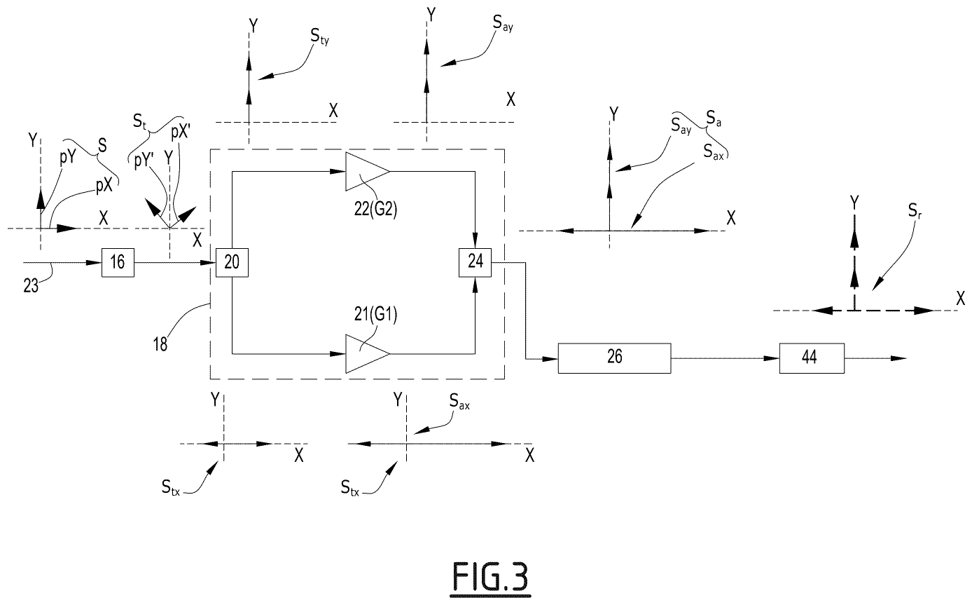

Referring to FIG. 3, the amplifier module 18 comprises a polarization beam splitter 20, also called PBS. Advantageously, the polarization beam splitter 20 is a passive optical device. The polarization beam splitter 20 is configured to divide an optical signal into two components, advantageously into two components whose polarization axes are orthogonal to each other.

The amplifier module 18 comprises two optical amplifiers 21 and 22. The optical amplifiers 21 and 22 are advantageously very high-power optical amplifiers. The optical amplifiers 21 and 22 are configured to amplify an optical signal passing through them with a respective gain G1 and gain G2. The gains G1 and G2 are advantageously predefined and chosen by a manufacturer of the amplifier module 18. In theory, the gains G1 and G2 are chosen to be equal. However, due to imperfections in the optical amplifiers 21 and 22, material constraints or the spatial environment, for example, the gains G1 and G2 are different in practice.

The amplifier module 18 also comprises a polarization beam combiner 24, also called PBC. The PBC 24 is advantageously a passive optical device. The PBC 24 advantageously combines two components whose axes are orthogonal into the same optical signal.

Advantageously, the optical modulator 14, the rotation module 16, and the amplifier 18 are connected to each other by polarization-maintaining fibers 23, also known as PMF (Polarization-Maintaining Fiber).

Advantageously, the transmitter 4 comprises an optical front end 26, also called an air interface module, and also known as an “optical front end” or OFE. The optical front end 26 advantageously comprises one or more of the following devices: an optical device, a pointing device, a collimation device, a coupling device, or even compensation or pre-compensation devices for atmospheric turbulence. These devices are active or passive and are formed of arrangements of lenses and/or mirrors, for example.

Referring to FIG. 2, the receiver 6 advantageously comprises an optical front end 32. This optical front end 32 is advantageously configured to receive an optical signal and to focus it into an optical fiber 34 which advantageously connects the optical front end 32 and an amplifier module 36, also included in the receiver 6. The amplifier module 36 is advantageously a low-noise amplifier.

The receiver 6 advantageously comprises an optical demodulator 38 and a digital processing module 42. Advantageously, the amplifier module 36 and the optical demodulator 38 are also connected by an optical fiber 34.

The optical demodulator 38 is configured to convert an optical signal into an electrical signal, representing the optical signal. Advantageously, the digital processing module 12, the optical modulator 14 on one hand, and the optical demodulator 38 and the digital processing module 42 on the other hand, correspond to each other. For example, the digital processing module 12 and the optical modulator 14 are configured to generate an optical signal according to coherent modulation, and the optical demodulator 38 and the digital processing module 42 are configured to perform operations that allow demodulation of a coherent optical signal.

The digital processing module 42 is implemented as a programmable logic component, such as an FPGA (Field Programmable Gate Array), or an integrated circuit, such as an ASIC (Application Specific Integrated Circuit), for example. In a variant, not shown, the digital processing module 42 is implemented as software, stored in the memory and executable by a processor associated with the memory. Likewise in a variant, not shown, the digital processing module 42 is implemented via optical analog components.

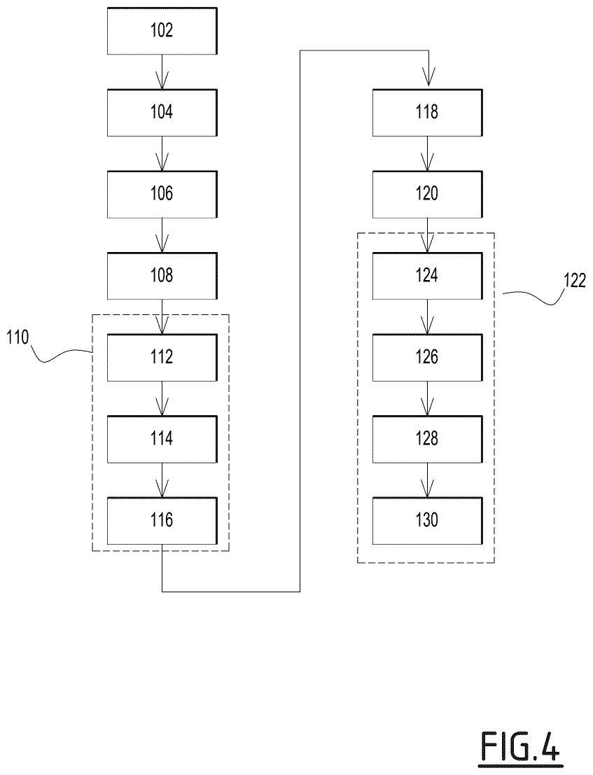

An information processing method will now be explained, with reference to FIGS. 3 and 4. This method is implemented by the transmission chain 1.

The digital processing module 12 advantageously receives input digital data Dₑ during a reception step 102. The input digital data Dₑ take the form of one or more electrical signals, for example, which encode information, such as bits of information.

The digital processing module 12 converts the input digital data Dₑ into an electrical signal Sₑₗ during a conversion step 104. The electrical signal Sₑₗ represents the input digital data Dₑ. Advantageously, during the conversion step 104, the digital processing module 12 implements functions or algorithms for error correction, pre-coding, or even signal frame shaping, for example. This enables improving the transmission of the electrical signal Sₑₗ, and limiting errors in the electrical signal Sₑₗ, that may be due to poor or partial reception of the input digital data Dₑ, for example.

The electrical signal Sₑₗ is transmitted to the optical modulator 14, which performs a modulation step 106. The modulation step 106 consists of generating a modulated optical signal S, representing the electrical signal Sₑₗ and therefore, of the input digital data Dₑ. Advantageously, in the case where the optical modulator 14 comprises a dual-polarization Mach-Zehnder interferometer comprising a laser source, the electrical signal Sₑₗ is applied to the laser source, to obtain the optical signal S at the output of the optical modulator 14. The modulation step 106 is a so-called dual-polarization modulation step, meaning that the optical signal S comprises two polarizations along two polarization axes X and Y, called polarization pX and polarization pY, respectively. Advantageously, the polarization axes X and Y are orthogonal.

The optical signal S is advantageously transmitted by the optical modulator 14 to the rotation module 16 via the polarization-maintaining fiber 23. This specifically prevents unintentional rotation or mixing of the polarizations pX and pY with each other during the transmission of the optical signal S to the rotation module 16.

During a rotation step 108, the optical signal S transmitted to the rotation module 16 is rotated by the latter, thus generating a rotated optical signal Sₜ. More precisely, the polarizations pX and pY are rotated by the rotation module 16 according to a rotation angle strictly between 0+kπ/2 and π/2+kπ/2, with k an integer. The integer k can be positive, negative, or zero. The rotation angle is expressed here in radians. The rotation angle is predefined by a manufacturer of the transmitter 4 and depends on the optical device included in the rotation module 16, such as the birefringent crystal type, or the Faraday rotator. The rotation angle, which is predefined, is fixed over time. Advantageously, the rotation angle of the polarizations pX and pY is between π/6+kπ/2 and π/3+kπ/2, preferably approximately equal to π/4+kπ/2 with k an integer. “Approximately equal to” a value means equal to this value, plus or minus 10%. The rotated polarizations pX and pY are noted pX′ and pY′. A rotation approximately equal to π/4+kπ/2 is obtained using a quarter-wave plate, for example, included in the rotation module 16. Thus, the rotated optical signal Sₜ comprises a polarization pX′ and a polarization pY′, advantageously rotated by π/4+kπ/2 with respect to the polarizations pX and pY of the optical signal S.

The rotated optical signal Sₜ is transmitted to the amplifier module 18, advantageously via the polarization-maintaining fiber 23, to prevent unintentional rotation of the polarizations pX′ and pY′.

An amplification step 110 is performed by the amplifier module 18, to generate an amplified optical signal Sₐ from the rotated optical signal Sₜ. The amplification step 110 advantageously comprises sub-steps 112 to 116.

Sub-step 112 is a separation sub-step. The rotated optical signal Sₜ is separated by the polarization beam splitter 20 into two optical components along two polarization axes of the splitter 20. The polarization axes of the splitter are advantageously aligned with the polarization axes X and Y of the optical signal S, as visible in FIG. 3. In the following, reference will be made to the polarization axes X and Y, including to designate the polarization axes of the splitter 20. Thus, during the separation sub-step 112, the rotated optical signal Sₜ is separated into an optical component Sₜₓ along the polarization axis X and an optical component S_{ty} along the polarization axis Y. The optical component Sₜₓ comprises the components of the polarizations pX′ and pY′ along the polarization axis X, and the optical component S_{ty} comprises the components of the polarizations pX′ and pY′ along the polarization axis Y, as represented in FIG. 3.

If, at step 108, the polarizations pX′ and pY′ are rotated by 45 degrees with respect to the polarization axes X and Y, then during the separation sub-step 112, the components of the polarizations pX′ and pY′ projected onto the polarization axes X and Y are of the same magnitude. Thus, in this case, the optical components Sₜₓ and S_{ty} are of the same magnitude.

The polarization splitter 20 transmits the optical components Sₜₓ and S_{ty} to the amplifiers 21 and 22.

The amplifiers 21 and 22 amplify the respective optical components Sₜₓ and S_{ty} during the component amplification sub-step 114. More precisely, the amplifier 21 amplifies the component Sₜₓ according to the gain G1, thus generating an amplified component Sₐₓ and the amplifier 22 amplifies the component S_{ty} according to the gain G2, thus generating an amplified component S_{ay}.

The polarization beam combiner 24 performs sub-step 116, which is a combination sub-step. During the combination sub-step 116, the components Sₐₓ and S_{ay} are transmitted to the polarization beam combiner 24, which combines them to form the amplified optical signal Sₐ. This transmission takes place via an optical fiber, or, in a variant, in free space. The amplified optical signal Sₐ represents the digital signal Sₑₗ and therefore the input data Dₑ.

The amplified optical signal Sₐ is then advantageously transmitted to the optical front end 26, via an optical fiber, for example, or, in a variant, in free space. The optical front end 26 performs an emission step 118 of the amplified optical signal Sₐ in a propagation medium 44, also called a propagation channel. Advantageously, during the emission step 118, the optical front end performs one or more of the following operations, depending on the devices included in the optical front end 26: a pointing operation, collimation, compensation, or pre-compensation, to improve the quality of the amplified signal Sₐ, and limit the losses or distortion caused by the amplified signal Sₐ emitted in the propagation medium 44.

The propagation medium 44 is an optical fiber, for example, or the atmosphere, in the case of free-space optical transmission, as represented in FIG. 1.

The amplified optical signal Sₐ is received by the receiver 6 during a reception step 120, advantageously by the optical front end 32.

The optical signal received by the receiver 6 is called the received optical signal Sᵣ. During the emission of the amplified optical signal Sₐ in the propagation medium 44, the amplified optical signal Sₐ is attenuated and its components Sₐₓ and S_{ay} are mixed, due to inhomogeneities of the propagation medium 44, for example, or, in the case of the atmosphere, turbulence or variations in the composition of the atmospheric layers. Thus, the amplified optical signal Sₐ as emitted by the transmitter 4 and the received optical signal Sᵣ by the receiver 6 are not identical, as represented in FIG. 3.

The receiver 6 performs a conversion step 122 of the received optical signal Sᵣ into output digital data Dₛ. For this, advantageously, the receiver 6 performs the following sub-steps 124 to 130.

Advantageously, the optical front end 32 focuses the received optical signal Sᵣ during the focusing sub-step 124 and transmits it to the amplification module 36 via the optical fiber 34. The amplification module 36 amplifies the received optical signal Sᵣ to form an amplified received optical signal Sₐ′ during the amplification sub-step 126.

The amplification module 36 transmits the amplified received optical signal Sₐ′ to the optical demodulator 38, which converts the amplified received optical signal Sₐ′ into a received electrical signal Sₑₗ′ during the conversion sub-step 128. The received electrical signal Sₑₗ′ is transmitted to the digital processing module 42 which performs the processing sub-step 130, during which it generates output digital data Dₛ, representing the input digital data Dₑ. In the case where the received optical signal Sᵣ is a coherent optical signal, the digital processing module 42 advantageously implements an adaptive equalization algorithm, such as the constant modulus algorithm, or CMA, a carrier and frame synchronization algorithm, or even decoding algorithms, for example, to generate the output digital data Dₛ.

In a variant, not shown, the optical signal comprises several wavelengths. The transmission chain is then modified as follows. The transmitter comprises a digital processing module and one optical modulator 14 per wavelength, as well as a multiplexer, connecting the optical modulators 14 and the rotation module 16. Thus, an optical signal composed of several wavelengths is received by the rotation module 16. In this case, advantageously, the rotation module 16 is a Faraday rotator whose operating wavelength band is several nanometers, to rotate all the multiplexed wavelengths.

In a variant, the multiplexer connects the amplifier 18 and the optical front end 26. In this case, the transmitter also comprises a rotation module 16 and one amplifier 18 per wavelength. Thus, in this case, each wavelength is rotated and amplified separately before being multiplexed.

The receiver 6 then also comprises a demultiplexer, which is connected to the optical front end 32. In this case, the receiver 6 comprises a plurality of amplifiers 36, optical demodulators 38, and digital processing modules 42, one amplifier 36 being connected to a single optical demodulator 38, itself connected to a single digital processing module 42, and configured to receive and process a given wavelength. In a variant, the demultiplexer is connected to the amplifier 36, and the receiver 6 comprises only a plurality of optical demodulators 38 and digital processing modules 42, one optical demodulator 38 being connected to a single digital processing module 42 to receive and process a given wavelength.

The previously described method is then implemented by this processing chain for each wavelength.

In practice, a given wavelength corresponds to an optical signal whose spectral width is less than 1 nm, for example.

Thus, the transmission chain 1 improves the quality of data transmission by optical signals by limiting the amplification differences between the two optical components Sₜₓ and S_{ty} of the rotated optical signal Sₜ, in a simple manner and without increasing the electricity consumption of the transmitter 4.

Any feature described for one embodiment or variant in the foregoing can be implemented for the other embodiments and variants described previously, as long as technically feasible.

1. A transmitter, configured to convert input digital data into an amplified optical signal and to emit the amplified optical signal, the transmitter comprising:
an optical modulator, configured to modulate an electrical signal representing the input digital data into an optical signal, comprising a first polarization along a first polarization axis and a second polarization along a second polarization axis, the optical signal representing the input digital data;
an optical rotation module, configured to generate a rotated optical signal by performing a rotation of the first and second polarizations of the optical signal according to a predefined rotation angle, strictly between 0+kπ/2 and π/2+kπ/2, with k an integer; and
an amplifier module, comprising:
a polarization beam splitter, configured to separate the rotated optical signal into a first optical component along the first polarization axis and a second optical component along the second polarization axis;
a first optical amplifier, configured to amplify the first optical component according to a predefined first gain;
a second optical amplifier, configured to amplify the second optical component according to a predefined second gain; and
a polarization beam combiner, configured to receive the first and second optical components, amplified by the respective first and second optical amplifiers, and to combine them into an amplified optical signal.

2. The transmitter according to claim 1, further comprising a digital processing module, configured to convert the input digital data into the electrical signal, representing the input digital data.

3. The transmitter according to claim 1, comprising an optical front end comprising at least one of the following devices: a collimation device, a pointing device, and a turbulence compensation device.

4. The transmitter according to claim 1, wherein the optical modulator is configured to transmit the optical signal to the rotation module, and the rotation module is configured to transmit the rotated optical signal to the amplifier module via a polarization-maintaining fiber.

5. The transmitter according to claim 1, wherein the optical rotation module comprises a birefringent crystal.

6. The transmitter according to claim 1, wherein the rotation angle is between π/6+kπ/2 and π/3+kπ/2, with k an integer.

7. The transmitter according to claim 1, wherein the rotation angle is approximately equal to π/4+kπ/2, with k an integer.

8. A receiver, adapted to receive the amplified optical signal emitted by the transmitter of claim 1, and to convert it into output digital data.

9. The receiver according to claim 8, comprising:
an optical front end, configured to receive the amplified optical signal, the received amplified optical signal being called the received optical signal;
an amplifier module, configured to amplify the received signal into an amplified received optical signal;
an optical demodulator, configured to convert the amplified received optical signal into a received electrical signal; and
a digital processing module, configured to implement an adaptive equalization algorithm and convert the received electrical signal into the output digital data.

10. A transmission chain comprising a transmitter, configured to convert input digital data into an amplified optical signal and to emit the amplified optical signal, the transmitter comprising:
an optical modulator, configured to modulate an electrical signal representing the input digital data into an optical signal, comprising a first polarization along a first polarization axis and a second polarization along a second polarization axis, the optical signal representing the input digital data;
an optical rotation module, configured to generate a rotated optical signal by performing a rotation of the first and second polarizations of the optical signal according to a predefined rotation angle, strictly between 0+kπ/2 and π/2+kπ/2, with k an integer; and
an amplifier module, comprising:
a polarization beam splitter, configured to separate the rotated optical signal into a first optical component along the first polarization axis and a second optical component along the second polarization axis;
a first optical amplifier, configured to amplify the first optical component according to a predefined first gain;
a second optical amplifier, configured to amplify the second optical component according to a predefined second gain; and
a polarization beam combiner, configured to receive the first and second optical components, amplified by the respective first and second optical amplifiers, and to combine them into an amplified optical signal,
and the receiver according to claim 8.

11. An information transmission method, implemented by a transmission chain according to claim 10, the method comprising at least the following steps:
modulation of the electrical signal representing the input digital data into the optical signal, by the optical modulator;
rotation of the first and second polarizations of the optical signal by the optical rotation module to generate the rotated optical signal;
amplification of the rotated optical signal by the amplifier module to generate the amplified optical signal;
emission of the amplified optical signal by the transmitter;
reception of the amplified optical signal by the receiver, the amplified optical signal received by the receiver being called the received optical signal; and
conversion of the received optical signal into output digital data by the receiver.
